(19) United States
(12) Patent Application Publication
(10) Pub. No.: US 2008/0155587 A1
(43) Pub. Date: Jun. 26, 2008

(54) Video Content Targeting System and Method

(75) Inventors: Ray L. Sokola, Blue Bell, PA (US); Robert P. Marley, North Wales, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/613,868

(22) Filed: Dec. 20, 2006

(51) Int. Cl. H04N 7/10; G06F 3/00

(52) U.S. Cl. 725/34; 725/44

(57) ABSTRACT

A system and method for collecting, in real-time, information related to the audience of a media appliance, and responsively providing content to that appliance as a function of the collected information. The invention may be implemented using known methods and systems for the real-time identification of individuals (biometric monitoring, mobile phone caller ID and ESN recognition, etc.).

### FIELD OF THE INVENTION

This invention relates to the field of media provisioning, and in particular to providing real-time reactive audio and video content as a function of the viewer or viewing audience.

### BACKGROUND OF THE INVENTION

Providing the most relevant programming (be it news, entertainment, educational, or advertising) to a given audience of media consumers is something that media outlets continually strive for. The value of providing a desired program or a properly targeted advertisement to a viewing audience is obvious, and a myriad of media research services providing polling/rating data are available to aid networks and programmers in properly determining what an audience might be receptive to (Nielsen Media Research, Arbitron, Q Ratings, etc.). While such ratings may provide useful information to direct future programming, and provide insights as to which types of people might be receptive to a particular advertising campaign, they do not provide a means by which programming or advertising can be tailored, in real-time, to a given viewing audience. For example, ratings/polling would provide an appropriate means of determining that 18 to 35 year-old males are likely to be the primary audience viewing a weekend sports broadcast, and that they would also be receptive to advertising for alcoholic beverages. However, if the audience in a particular household watching that broadcast was primarily made up of females over the age of 40 and/or children under the age of 15, the broadcaster would probably be well-advised to provide very different advertising to address the likely wants of this anomalous audience. Present systems are ill-equipped to permit broadcasters and other media providers to adapt programming/advertising in real-time to meet the needs of a particular audience.

It would be advantageous, therefore, to provide a system for making a real-time determination of the make-up of a given audience listening and/or viewing a particular media appliance (such as a video or computer display, or satellite radio receiver), and reactively provide video programming and/or advertising on that media appliance to meet the likely listening, viewing or purchasing preferences of that audience.

### SUMMARY OF THE INVENTION

In accordance with the principles of this invention a system and method for collecting, in real-time, information related to the audience of a media appliance, and responsively providing content to that appliance as a function of the collected information. This invention may be implemented using known methods and systems for the real-time identification of individuals (biometric monitoring, mobile phone caller ID and ESN recognition, etc.).

### BRIEF DESCRIPTION OF THE DRAWINGS

For a complete understanding of the present invention and the advantages thereof, reference is now made to the following description taken in conjunction with the accompanying drawings, wherein:

FIG. 1 is a diagram of a first preferred embodiment of a media targeting system;

FIG. 2 is a flowchart diagram of the steps for providing targeted media to an audience.

### DESCRIPTION OF PREFERRED EMBODIMENTS

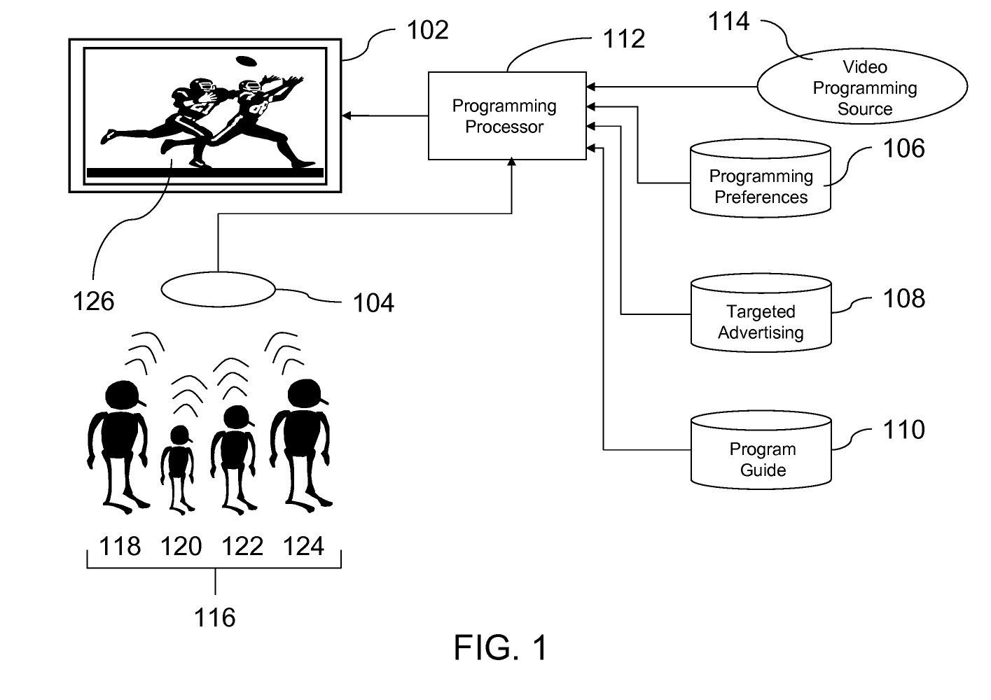

Referring to FIG. 1, in a preferred embodiment the system includes video monitor 102, an audience sensor 104, a database of audience programming preferences 106, a targeted advertising data base 108, a program guide of available programming content 110, and a programming processor. Programming processor 112 is also adapted to receive information from video programming source 114. This source could include real-time programming provided by cable or broadcast, or a video-on-demand server, or a feed from a library of stored video content.

For purposes of describing this preferred embodiment, an audience 116 of viewers (118, 120, 122, 124) will assumed. As with any viewing audience the individuals within it are likely to differ in age, be either male or female, and have dissimilar social and economics backgrounds. Audience sensor 104 operates to collect information on as many of the viewing individuals as possible. For purposes of illustration and ease of discussion, audience sensor 104 is depicted as a unitary device. However, this sensor could be comprised of multiple sensors, or multiple arrays of sensors. This collected information may be the ESNs or phone numbers of active mobile communication devices (phones, PDAs, etc.) being carried by the individuals. It could also consist of biometric data such as height, facial structure, retinal patterns, etc. It could include e-mail addresses collected from wireless data appliances (computers, PDAs, etc.). Furthermore, this collected information could be indicative of where a particular individual had recently traveled based upon GPS or other location data collected by a PDA, cell phone or other personal appliance. Audience sensor 104 may be a passive device, such as an antenna or a thermal sensor, or an active device directing radio frequency inquiries to the electronic devices carried by the audience members and/or establishing bidirectional communication with such devices. Audience sensor 104 could collect information in a continuous manner, providing information on sensed individuals periodically to programming processor 112. Audience sensor 104 might also be configured to take a periodic “snapshot” of the audience, providing information to programming processor 112 after each such snapshot. Numerous sensing systems such as those briefly described above are well-known in the art, and any such could be employed within the invention.

Programming processor 112, comprised of video switching means, and one or more processing means such as programmable microprocessors and/or dedicated processing circuitry, receives the audience information from audience sensor 104. Programming processor 112 may be collocated with audience sensor 112 and video monitor 102, or remotely located and connected to audience sensor 112 and video monitor 102 via a public or private network (wired or wireless).

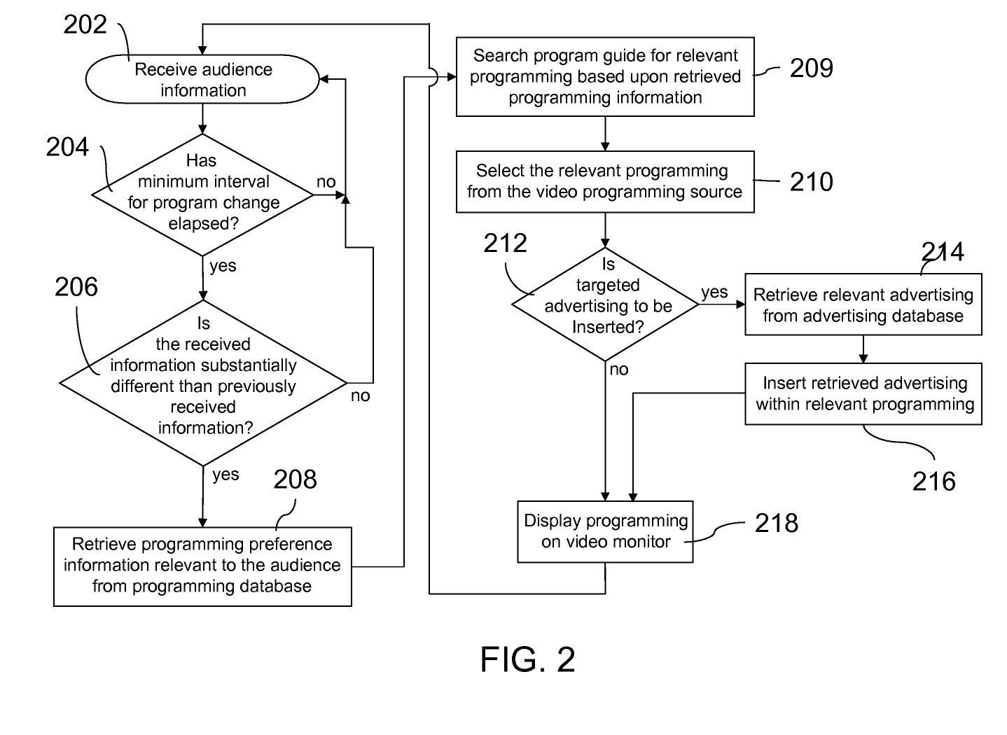

Upon receipt of the audience information (202) the programming processor performs the steps represented in FIG. 2. In order to prevent rapid video programming changes that the audience might find annoying, the system is preprogrammed to prohibit such. As shown in decision box 204, a minimum interval must elapse prior to the system determining if the video programming being sent to video monitor 102 should be changed. This interval may be a fixed number of minutes or hours, or it may be set to coincide with the termination of whatever particular video program is presently being viewed. For example, the system will not make a determination as to what new video programming should be displayed prior to the termination of the football game presently being viewed. If the interval has elapsed, the system then determines (decision box 206) if the received audience information is substantially different than previously received audience information. For example, has the male/female ratio changed, or are there now a significant number children viewing the video monitor. The definition of what would qualify as a substantial difference would be left to the administrator of the system. Programming processor 112 could be instructed to change the video being viewed only if there was a 50% shift in the male/female ration, or it could be programmed to change the video being viewed if a single child was detected, if the video programming was rated as inappropriate for young viewers.

Once programming processor 112 establishes that a substantial change in the viewing audience has occurred, preference information relevant to the new audience is retrieved from programming preference database 106 (step 208). This may be generic information provided by the source of the video content. For example, a particular show may have a very high Neilsen rating among adult females, or a particular documentary is not suitable for viewing by children under the age of 14. The preference information might also be unrelated to what the members of the audience might find enjoyable. It could contain standardized content ratings such as the Motion Picture Association of America (“MPAA”) ratings of G, PG, PG-13, R, and NC-17, or the Television Parental Guidelines of TV-Y, TV-Y&, TV-Y&FV, TV-G, TV-PG, YV-14 and TV-MA. It could also be based upon what the administrator of the system wants a certain group or demographic to view. If the viewing area is full of males between the ages of 30 and 40, the administrator may want a particular advertisement for an automobile or beverage inserted, or perhaps a television show that isn't doing well with that particular demographic in the hope that viewing the show might spark interest. The preference information could even be personal. The system could be deployed in a residential setting with individual members of a given household (118, 120, 122, 124) being recognized and their very specific preferences being retrieved by the system.

Once retrieving the programming preference, the system searches program guide 110 containing all available video programming options from video programming source (step 209), and the most relevant programming option is selected based upon the retrieved programming preferences. This programming guide could be one that is dedicated to the particular video programming source, or a more generic source of information such as the Internet. The system then retrieves, tunes, decodes, or otherwise acquires the most relevant programming option from video programming source 114 (step 210).

At this juncture, the system would check to see if the administrator had programmed the insertion of targeted advertising or commercials (step 212). If no such insertions were programmed, the system would display the video programming 126 obtained from video programming source 114 (step 218). However, if such insertion was required, the appropriate advertisements/commercials would be retrieved from targeted advertising database 108 (step 214), and inserted within video programming 126 (step 216). This advertising/commercial insertion would be done so that the inserted information would be seen prior to, immediately following or during video programming 126. The video programming, including the inserted advertisements/commercials would then be sent to video display 102 for viewing by audience 116 (step 218). The entire process then repeats, with programming processor 112 receiving new information from audience sensor 104 (step 202).

Furthermore, although the invention has been described herein by reference to exemplary embodiments thereof, it will be understood that modification and variation to such, without departing from the inventive concepts disclosed, can be made. All such modifications and variations, therefore, are intended to be encompassed within the spirit and scope of the appended claims. For example, the system could provide particular media to a given individual or audience on strict permission basis. If a given individual or audience had not provided the system with express permission for a particular item to be displayed or played, no such item would be retrieved by the system regardless of the individual/audience informationm that was collected.

We claim:

1. A system for collecting information related to at least one consumer of media content, and responsively providing content to the at least one consumer of media via a media appliance as a function of the collected information, the system comprising:
at least one media appliance adapted for delivering media content to one or more media consumers;
a mediaprogram source;
a sensor, co-located with the at least one media appliance, and adapted to collect information indicative of at least one characteristic associated with the at least one consumer of media;
a program guide providing containing a description of all programming options available from the media program source;
a programming preference database providing a mapping of characteristics associated with the at least one consumer of media to program content descriptors;
a programming processor adapted to receive the indicative information collected by the sensor, compare the received indicative information to the characteristics within the programming preference database to obtain an associated program content descriptor, locate media content available from the media program source based upon the program content descriptor, and direct the located media content to the at least one consumer of media via the at least one media appliance.

2. The system of claim 1, further comprising:
a message database comprising a plurality of messages adapted for insertion into the media content available from the media program source, wherein the programming processor is further adapted to locate at least one of the messages based upon the indicative information, and insert the located message within the content being directed to the at least one media appliance for consumption.

3. The system of claim 2, wherein the message is a commercial advertisement.

4. The system of claim 2, wherein the message is directed to an individual viewer.

5. The system of claim 1, wherein the at least one characteristic associated with at least one media consumer comprises data associated with a mobile communication device.

6. The system of claim 1, wherein the at least one characteristic associated with at least one media consumer comprises biometric data.

7. The system of claim 1, wherein the at least one characteristic associated with at least one media consumer comprises location-specific data.

8. The system of claim 7, wherein the location-specific information comprises global positioning system information.

9. The system of claim 1, wherein the media program source comprises a cable or over-the-air broadcast network.

10. The system of claim 1, wherein the media program source comprises the Internet.

11. The system of claim 1, wherein the media program source comprises a video-on-demand server.

12. The system of claim 1, wherein the media program source comprises a memory storing video programming.

13. The system of claim 1, wherein the program content descriptors comprise standardized content ratings.

14. The system of claim 1, wherein the program content descriptors comprise audience preference ratings compiled by a media research service.

15. The system of claim 1, wherein the media appliance is a video monitor.

16. The system of claim 1, wherein the programming processor is further adapted to inhibit the comparison of the received indicative information to the characteristics within the programming preference database and the subsequent direction of located media content to the at least one media appliance if a minimum interval has not elapsed since a previous direction of located media content to the at least one media appliance.

17. The system of claim 16, wherein the minimum interval is a fixed interval.

18. The system of claim 16, wherein the minimum interval elapses at the termination of the particular content being viewed on the at least one video monitor.

19. A method for collecting information related to at least one consumer of media content, and responsively providing media content a media appliance, the method comprising the steps of:
automatically collecting real-time information indicative of at least one characteristic associated with the at least one consumer of media;
determining program content descriptors as a function of comparing the collected indicative information to a database of media consumer characteristics;
locating content available from a media program source based upon the determined program content descriptor; and
directing the located media content to a media appliance for consumption by the the at least one media consumer.

20. The method of claim 19, further comprising:
locating, as a function of the collected indicative information, at least one message to be inserted within the located media content; and
inserting the located message within the located media content for consumption by the at least one media consumer via the media appliance.

21. The method of claim 20, wherein the message is a commercial advertisement.

22. The method of claim 20, wherein the message is directed to an individual viewer.

23. The method of claim 19, wherein the at least one characteristic associated with at least one consumer of media comprises data associated with a mobile communication device.

24. The method of claim 19, wherein the at least one characteristic associated with at least one consumer of media comprises biometric data.

25. The method of claim 19, wherein the at least one characteristic associated with at least one media consumer comprises location-specific data.

26. The method of claim 19, wherein the location-specific information comprises global positioning system information.

27. The method of claim 19, wherein the media program source comprises a cable or over-the-air broadcast network.

28. The method of claim 19, wherein the media program source comprises the Internet.

29. The method of claim 19, wherein the media program source comprises the Internet.

30. The method of claim 19, wherein the media program source comprises a video-on-demand server.

31. The method of claim 19, wherein the media program source comprises a memory storing video programming.

32. The method of claim 19, wherein the program content descriptors comprise standardized content ratings.

33. The method of claim 19, wherein the program content descriptors comprise audience preference ratings compiled by a media research service.

34. The method of claim 19, wherein the media appliance is a video monitor.

35. The method of claim 19 further comprising:
prohibiting the direction of the located media content to the media appliance for consumption if a minimum interval has not elapsed since a previous direction of located media content to the media appliance.

36. The method of claim 35, wherein the minimum interval is a fixed interval.

37. The method of claim 35, wherein the minimum interval elapses at the termination of the particular content being consumed via the media appliance.
